(19) United States
(12) Patent Application Publication
(10) Pub. No.: US 2017/0116393 A1
(43) Pub. Date: Apr. 27, 2017

(54) DRM SERVICE PROVISION APPARATUS AND METHOD, AND CONTENT PLAYBACK APPARATUS AND METHOD USING DRM SERVICE

(71) Applicant: SAMSUNG SDS CO., LTD., Seoul (KR)

(72) Inventors: Kyu-Young Choi, Seoul (KR); Ji-Hoon Cho, Seoul (KR); Duk-Jae Moon, Seoul (KR)

(73) Assignee: SAMSUNG SDS CO., LTD., Seoul (KR)

(21) Appl. No.: 14/980,521

(22) Filed: Dec. 28, 2015

(30) Foreign Application Priority Data
Oct. 26, 2015 (KR) 10-2015-0148447

(51) Int. Cl. G06F 21/10; G09C 1/00; H04L 9/06

(52) U.S. Cl. CPC G06F 21/10; H04L 9/06; G09C 1/00; G06F 2221/0753

(57) ABSTRACT

A digital rights management (DRM) provision apparatus includes a first encryptor configured to encrypt content using a first white-box cryptograph (WBC)-based encryption, in which a first secret key is internalized, and a symmetric key-based encryption using a content encryption key; a second encryptor configured to encrypt the content encryption key using a second WBC-based encryption in which a second secret key is internalized; and a transmitter configured to transmit the encrypted content and the encrypted content encryption key to a content playback apparatus of a registered user.

### CROSS-REFERENCE TO RELATED APPLICATION

This application claims priority to and the benefit of Korean Patent Application No. 10-2015-0148447, filed on Oct. 26, 2015, the disclosure of which is incorporated herein by reference in its entirety.

### BACKGROUND

1. Field

Exemplary embodiments of the present disclosure relate to technology for providing a digital rights management (DRM) service.

2. Discussion of Related Art

A conventional digital rights management (DRM) service has used both public key encryption and symmetric key encryption in order to encode and safely transmit content, and has further used a white-box cryptography (WBC) algorithm in order to protect an encryption key.

The conventional method has problems in that a lot of content is illegally distributed due to structural complexity resulting from the use of all kinds of cryptographic algorithms and many important keys have been exposed to memory attacks by hackers.

### SUMMARY

The present disclosure is directed to a digital rights management (DRM) service provision apparatus and method, and a content playback apparatus and method.

According to an aspect of an exemplary embodiment, provided is a digital rights management (DRM) provision apparatus, including: a first encryptor configured to encrypt content using a first white-box cryptograph (WBC)-based encryption, in which a first secret key is internalized, and a symmetric key-based encryption using a content encryption key; a second encryptor configured to encrypt the content encryption key using a second WBC-based encryption in which a second secret key is internalized; and a transmitter configured to transmit the encrypted content and the encrypted content encryption key to a content playback apparatus of a registered user.

The encrypted content may include a first cryptogram encrypted by the first WBC-based encryption and a second cryptogram encrypted by the symmetric key-based encryption.

The first encryptor may be further configured to generate the first cryptogram by applying the first WBC-based encryption to a portion of the content or a seed value, and generate the second cryptogram by applying the symmetric key-based encryption to another portion of the content to which the first WBC-based encryption is not applied.

The first encryptor may be further configured to generate the second cryptogram based on the portion of the content or the seed value.

The seed value may include an initialization vector or a counter value.

The first secret key may include a server secret key.

The second secret key may include a user secret key.

According to an aspect of another exemplary embodiment, provided is a DRM service provision method, including: encrypting content using a first WBC-based encryption, in which a first secret key is internalized, and a symmetric key-based encryption using a content encryption key; encrypting the content encryption key using a second WBC-based encryption in which a second secret key is internalized; and transmitting the encrypted content and the encrypted content encryption key to a content playback apparatus of a registered user.

The encrypted content may include a first cryptogram encrypted by the first WBC-based encryption and a second cryptogram encrypted by the symmetric key-based encryption.

The encrypting the content may include generating the first cryptogram by applying the first WBC-based encryption to a portion of the content or a seed value; and generating the second cryptogram by applying the symmetric key-based encryption to another portion of the content to which the first WBC-based encryption is not applied.

The generating the second cryptogram may include generating the second cryptogram based on the portion of the content or the seed value.

The seed value may include an initialization vector or a counter value.

The first secret key may include a server secret key.

The second secret key may include a user secret key.

According to an aspect of still another exemplary embodiment, provided is a content playback apparatus, including: a receiver configured to receive encrypted content and a cryptogram on a content encryption key, the content encryption key being used to generate the encrypted content; a first decryptor configured to decrypt the cryptogram on the content encryption key using a first WBC-based decryption in which a first secret key is internalized; and a second decryptor configured to decrypt the encrypted content using a second WBC-based decryption, in which a second secret key is internalized, and a symmetric key-based decryption using the content encryption key.

The encrypted content may include a first cryptogram encrypted using a WBC-based encryption, in which the second secret key is internalized, and a second cryptogram encrypted using a symmetric key-based encryption using the content encryption key, and the second decryptor may be further configured to apply the second WBC-based decryption to the first cryptogram, apply the symmetric key-based decryption to the second cryptogram, and decrypt the encrypted content.

The second decryptor may be further configured to decrypt the second cryptogram using information decrypted by the second WBC-based decryption.

The decrypted information may include a portion of content or a seed value.

The seed value may include an initialization vector or a counter value.

The second secret key may include a server secret key.

The first secret key may include a user secret key.

According to an aspect of still another exemplary embodiment, provided is a content playback method, including: receiving encrypted content and a cryptogram on a content encryption key, the content encryption key being used to generate the encrypted content; decrypting the cryptogram on the content encryption key using a first WBC-based decryption in which a first secret key is internalized; and decrypting the encrypted content using a second WBC-based decryption, in which a second secret key is internalized, and a symmetric key-based decryption using the content encryption key.

The encrypted content may include a first cryptogram encrypted using a WBC-based encryption, in which the second secret key is internalized, and a second cryptogram encrypted using a symmetric key-based encryption using the content encryption key, and the decrypting the encrypted content may include applying the second WBC-based decryption to the first cryptogram, applying the symmetric key-based decryption to the second cryptogram, and decrypting the encrypted content.

The decrypting the encrypted content may include decrypting the second cryptogram using information decrypted by the second WBC-based decryption.

The decrypted information may include a portion of content or a seed value.

The seed value may include an initialization vector or a counter value.

The second secret key may include a server secret key.

The first secret key may include a user secret key.

According to an aspect of still another exemplary embodiment, provided is a computer-readable recording medium storing a program which, when executed by a computer, causes the computer to perform a method including: encrypting content using a first WBC-based encryption, in which a first secret key is internalized, and a symmetric key-based encryption using a content encryption key; encrypting the content encryption key using a second WBC-based encryption in which a second secret key is internalized; and transmitting the encrypted content and the encrypted content encryption key to a content playback apparatus of a registered user.

According to an aspect of still another exemplary embodiment, provided is a computer-readable recording medium storing a program which, when executed by a computer, causes the computer to perform a method including: receiving encrypted content and a cryptogram on a content encryption key, the content encryption key being used to generate the encrypted content; decrypting the cryptogram on the content encryption key using a first WBC-based decryption in which a first secret key is internalized; and decrypting the encrypted content using a second WBC-based decryption, in which a second secret key is internalized, and a symmetric key-based decryption using the content encryption key.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a diagram illustrating a configuration of a digital rights management (DRM) service provision system according to an exemplary embodiment of the inventive concept;

FIG. 2 is a diagram illustrating a configuration of a DRM service provision apparatus according to an exemplary embodiment of the inventive concept;

FIG. 3 is a diagram illustrating a configuration of a content playback apparatus according to an exemplary embodiment of the inventive concept;

FIGS. 4A and 4B are diagrams for describing a propagating cipher block chaining (PCBC) mode according to one exemplary embodiment of the inventive concept;

FIGS. 5A and 5B are diagrams for describing an output feedback (OFB) mode according to one exemplary embodiment of the inventive concept;

FIGS. 6A and 6B are diagrams for describing a PCBC mode according to another exemplary embodiment of the inventive concept;

FIGS. 7A and 7B are diagrams for describing an OFB mode according to another exemplary embodiment of the inventive concept;

FIGS. 8A and 8B are diagrams for describing a counter mode according to an exemplary embodiment of the inventive concept;

FIG. 9 is a flowchart for describing a DRM service provision method according to an exemplary embodiment of the inventive concept; and

FIG. 10 is a flowchart for describing a content playback method according to an exemplary embodiment of the inventive concept.

### DETAILED DESCRIPTION OF EXEMPLARY EMBODIMENTS

Hereinafter, exemplary embodiments of the inventive concept will be described with references to the accompanying drawings. The following description is provided in order to help a comprehensive understanding with respect to a method, apparatus, or system or all of them described herein. However, it is merely an example, and is not limited thereto.

With respect to the following description of the exemplary embodiments of the present disclosure, when it is determined that a detailed description of a well-known technology related to the present disclosure can unnecessarily obscure the subject matter of the present disclosure, the description will be omitted. All terms used herein are terms defined by considering functions in the inventive concept, and may be different according to the intentions or the customary use by a user, or an operator. Accordingly, the terms should be defined based on the description of this specification. The terms used herein are only for describing exemplary embodiments according to the inventive concept, and should not be interpreted to limit. Unless otherwise defined, the use of the singular form in the present document should not preclude the presence of more than one referent. It will be further understood that the terms “comprises,” “comprising,” “includes,” or “including,” or all of them when used herein, specify the presence of stated features, items, steps, operations, elements, or components, or all of them, but do not preclude the presence or addition of one or more other features, items, steps, operations, elements, components, or groups or all of them thereof.

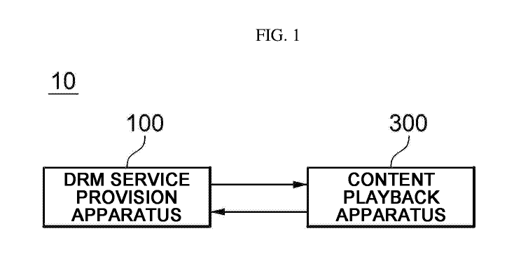

FIG. 1 is a diagram illustrating a configuration of a digital rights management (DRM) service provision system according to an exemplary embodiment of the inventive concept.

Referring to FIG. 1, a DRM service provision system 10 may include a DRM service provision apparatus 100, and a content playback apparatus 300.

The DRM service provision apparatus 100 may encrypt content, provide the encrypted content to the content playback apparatus 300, encrypt a content encryption key used for content encryption, and provide the encrypted content encryption key to the content playback apparatus 300. The DRM service provision apparatus 100 may be implemented as a server or one component included in a corresponding server for providing a DRM service.

The content playback apparatus 300 may receive the encrypted content and a cryptogram on a content encryption key for decrypting the encrypted content from the DRM service provision apparatus 100 through a wired network or wireless network or both, and play the encrypted content after decrypting the encrypted content. For example, the content playback apparatus 300 may be implemented as one component included in various types of devices such as a set-top box, a lap-top personal computer (PC), a desktop PC, a smart phone, a personal digital assistant (PDA), a smart television (TV), etc.

Meanwhile, according to an exemplary embodiment of the inventive concept, as a setup operation for providing the DRM service before transmitting the encrypted content and the cryptogram on the content encryption key, the DRM service provision apparatus 100 and the content playback apparatus 300 may perform user registration, application distribution for the DRM service, and distribution of an encryption algorithm, etc.

For example, the content playback apparatus 300 may request a user registration for receiving the DRM service to the DRM service provision apparatus 100, and the DRM service provision apparatus 100 may register the corresponding subject user according to the request for the user registration.

After this, the DRM service provision apparatus 100 may generate the encryption algorithm for encrypting/decrypting the content and the encryption algorithm for encrypting/decrypting the content encryption key, and distribute the generated encryption algorithms to the content playback apparatus 300 of the registered user.

In this case, the encryption algorithm for encrypting/decrypting the content may be an encryption algorithm designed to encrypt the content using a white-box cryptograph (hereinafter, WBC)-based encryption in which a first secret key is internalized and a symmetric key-based encryption using a content encryption key on the content.

In this case, for example, the first secret key may be configured as an arbitrary bit string, and the same value may be used as the first secret key regardless of the user of the content playback apparatus 300 receiving the encrypted content or content to be encrypted. In detail, the first secret key may be a server secret key generated by the DRM service provision apparatus 100.

Meanwhile, the encryption algorithm for encrypting/decrypting the content encryption key may be an encryption algorithm designed to encrypt the content encryption key using the WBC-based encryption in which a second secret key is internalized.

In this case, for example, the second secret key may be configured as an arbitrary bit string, and be different for each registered user. In detail, for example, the second secret key for each user may be a user secret key generated by the DRM service provision apparatus 100 when registering the user .

Meanwhile, according to an exemplary embodiment of the inventive concept, after performing the setup operation described above, the DRM service provision apparatus 100 may generate the content encryption key, encrypt the content using the generated content encryption key and the encryption algorithm for encrypting the content or decrypting the content or both, and provide the encrypted content to the content playback apparatus 300 of the registered user. In this case, the value of the content encryption key that is generated may be different from a value for each content to be encrypted.

The user of the content playback apparatus 300 receiving the encrypted content may request user authentication to the DRM service provision apparatus 100 in order to execute the encrypted content, and when the user authentication is successful, the DRM service provision apparatus 100 may encrypt the content encryption key using the encryption algorithm for encrypting the content encrypting key or decrypting the content encryption key or both, and provide the encrypted content encryption key to the content playback apparatus 300 of the authenticated user.

The content playback apparatus 300 receiving the encrypted content encryption key may decrypt the encrypted content encryption key using the encryption algorithm for encrypting the content encryption key or decrypting the content encryption key or both distributed by the DRM service provision apparatus 100.

After this, the content playback apparatus 300 may execute the content after decrypting the encrypted content using the decrypted content encryption key and the encryption algorithm of encrypting the content or decrypting the content or both distributed by the DRM service provision apparatus 100.

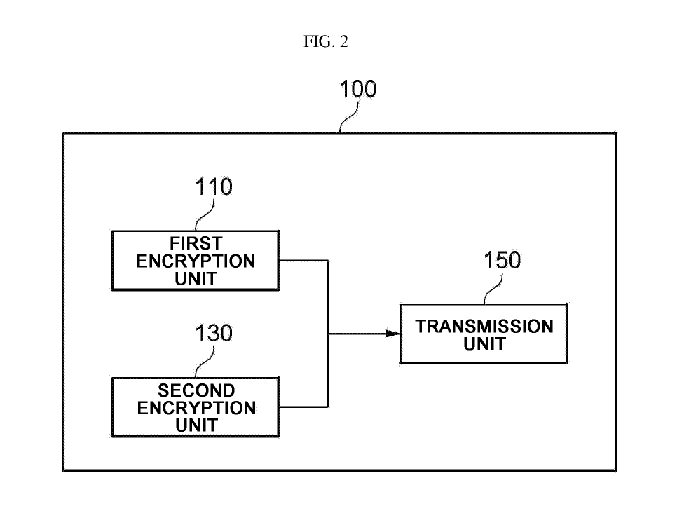

FIG. 2 is a diagram illustrating a configuration of a DRM service provision apparatus 100 according to an exemplary embodiment of the inventive concept.

Referring to FIG. 2, the DRM service provision apparatus 100 may include a first encryption unit (or first encryptor) 110, a second encryption unit (or second encryptor) 130, and a transmission unit (or transmitter) 150.

The first encryption unit 110 may encrypt the content to be provided to the content playback apparatus 300 using the WBC-based encryption in which the first secret key is internalized and the symmetric key-based encryption using the content encryption key on the content.

In this case, for example, the WBC-based encryption in which the first encryption key is internalized may mean the encryption using the WBC algorithm in which the first secret key is hidden in the encryption algorithm in the form of a look-up table.

Further, for example, the symmetric key-based encryption may mean the encryption using a conventional symmetric key-based block encryption algorithm of various methods such as advanced encryption standard (AES), data encryption standard (DES), triple data encryption standard (3DES), Blowfish, etc.

According to an exemplary embodiment of the inventive concept, the first encryption unit 110 may perform the encryption by applying the WBC-based encryption in which the first secret key is internalized in a portion of the content or a seed value, and perform the encryption by applying the symmetric key-based encryption using the content encryption key to a remaining portion of the content (that is, a non-encrypted portion). Accordingly, the content encrypted by the first encryption unit 110 may include a cryptogram encrypted by the WBC-based encryption in which the first secret key is internalized and a cryptogram encrypted by the symmetric key-based encryption.

Meanwhile, the seed value may mean an initial input value capable of being represented by a bit string, and for example, include a counter value or an initialization vector configured as an arbitrary bit string, etc.

Meanwhile, according to an exemplary embodiment of the inventive concept, the first encryption unit 110 may use the portion of the content or the seed value encrypted by the WBC-based encryption in which the first secret key is internalized for generating the cryptogram using the symmetric key-based encryption, and allow information encrypted by the WBC-based encryption in which the server key is internalized to be used for decrypting the symmetric key-based cryptogram when decrypting the encrypted content.

In detail, the first encryption unit 110 may encrypt the content in units of blocks using an operating mode that uses the WBC-based encryption in which the first secret key is internalized and the symmetric key-based encryption using the content encryption key, and in this case, the operating mode may be defined so that the decryption of the cryptogram encrypted by the WBC-based encryption in which the first secret key is internalized is essential for the decryption of the cryptogram encrypted by the symmetric key-based encryption (a detailed description thereof will be described hereinafter). Accordingly, the first secret key in the memory may not be exposed even when the content encryption key is exposed by memory attacks on the encryption of the content and the decryption of the encrypted content, and the decryption of the encrypted content may not be possible without the decryption of the cryptogram encrypted by the WBC-based encryption.

The second encryption unit 130 may encrypt the content encryption key used for encrypting the content by the first encryption unit 110 using the WBC-based encryption in which the second secret key for the registered user is internalized.

In this case, for example, the WBC-based encryption in which the second secret key is internalized may mean the encryption using the encryption algorithm in which the second secret key is hidden in the encryption algorithm in the form of a look-up table.

The transmission unit 150 may transmit the encrypted content generated by the first encryption unit 110 and the encrypted content encryption key generated by the second encryption unit 130 to the content playback apparatus 300 of the registered user.

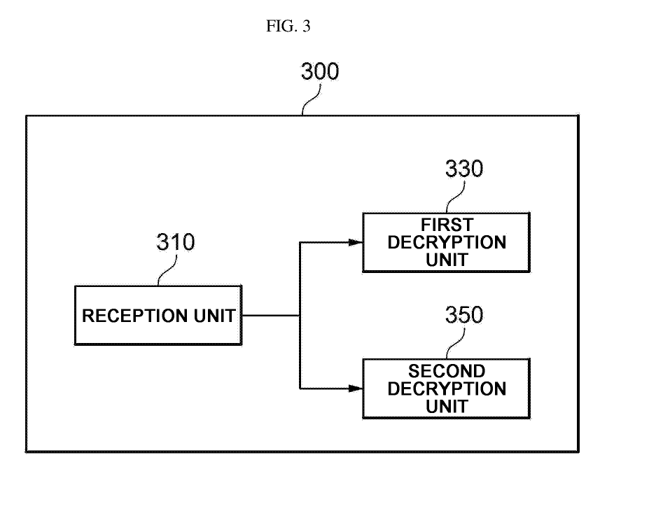

FIG. 3 is a diagram illustrating a content playback apparatus according to an exemplary embodiment of the inventive concept.

Referring to FIG. 3, the content playback apparatus 300 according to an exemplary embodiment of the inventive concept may include a reception unit (or receiver) 310, a first decryption unit (or first decryptor) 330, and a second decryption unit (or second decryptor) 350.

The reception unit 310 may receive the encrypted content and the cryptogram on the content encryption key used for encrypting the corresponding encrypted content from the DRM service provision apparatus 100.

In this case, the encrypted content transmitted to the reception unit 310 may include the cryptogram encrypted using the WBC-based encryption in which the first secret key is internalized, and the cryptogram encrypted using the symmetric key-based encryption using the content encryption key.

The first decryption unit 330 may decrypt the cryptogram on the content encryption key using a WBC-based decryption in which the second secret key is internalized. In this case, for example, the WBC-based decryption in which the secret key of the user is internalized may mean the decryption using the WBC algorithm in which the second secret key is hidden in the algorithm in the form of the look-up table.

The second decryption unit 350 may decrypt the encrypted content by applying the WBC-based decryption in which the first secret key is internalized to a portion of the encrypted content, and applying the symmetric key-based decryption using the content encryption key decrypted by the first decryption unit 330 to a remaining portion of the encrypted content (that is, a portion which is not decrypted by the WBC-based decryption). In this case, for example, the WBC-based decryption in which the first secret key is internalized may mean the decryption using the WBC algorithm in which the first secret key is internalized in the algorithm in the form of a look-up table.

In detail, the second decryption unit 350 may decrypt the encrypted content by applying the WBC-based decryption in which the first secret key is internalized to the cryptogram encrypted by the WBC-based encryption in which the first secret key is internalized within the encrypted content, and applying a symmetric key-based decryption using the content encryption key decrypted by the first decryption unit 330 to the cryptogram encrypted using the symmetric key-based encryption using the content encryption key.

In this case, according to an exemplary embodiment of the inventive concept, the second decryption unit 350 may use information decrypted by the WBC-based decryption in which the first secret key is internalized for decrypting the cryptogram encrypted using the symmetric key-based algorithm using the content encryption key. That is, as described above, the DRM service provision apparatus 100 may first perform the decryption of a portion encrypted by the WBC-based encryption in which the first secret key is internalized for decrypting the encrypted content, since a portion of the content encrypted by the WBC-based encryption in which the first secret key is internalized or the seed value is used for generating the cryptogram using the symmetric key-based encryption when encrypting the content.

In detail, the second decryption unit 350 may decrypt the encrypted content in units of blocks using the operating mode that uses the WBC-based decryption in which the first secret key is internalized and the symmetric key-based decryption using the content encryption key, and in this case, the operating mode may be defined so that the decryption of the cryptogram encrypted by the WBC-based encryption in which the first secret key is internalized is essential for the decryption of the cryptogram encrypted by the symmetric key-based encryption (a detailed description thereof will be described hereinafter). Accordingly, the first secret key in the memory of the content playback apparatus 300 may not be exposed even when the content encryption key is exposed by memory attacks on the decryption of the encrypted content, and the decryption of the encrypted content may not be possible without the decryption on the cryptogram encrypted by the WBC-based encryption.

Meanwhile, in an exemplary embodiment, the first encryption unit 110, the second encryption unit 130, the transmission unit 150, the reception unit 310, the first decryption unit 330, and the second decryption unit 350, shown in FIGS. 2 and 3, may be implemented in one or more computing devices including one or more processors and a computer-readable recording medium connected to the processors. The computer-readable recording medium may be located inside or outside the processors, and be connected to the processors by various well-known means. The processor located inside the computing device may allow each computing device to operate according to exemplary embodiments described herein. For example, the processor may execute an instruction stored in the computer-readable recording medium, and be configured to allow the computing device to perform operations according to exemplary embodiments described herein when the instruction stored in the computer-readable recording medium is executed by the processor. The processor may include a central processing unit (CPU), a microprocessor, or the like.

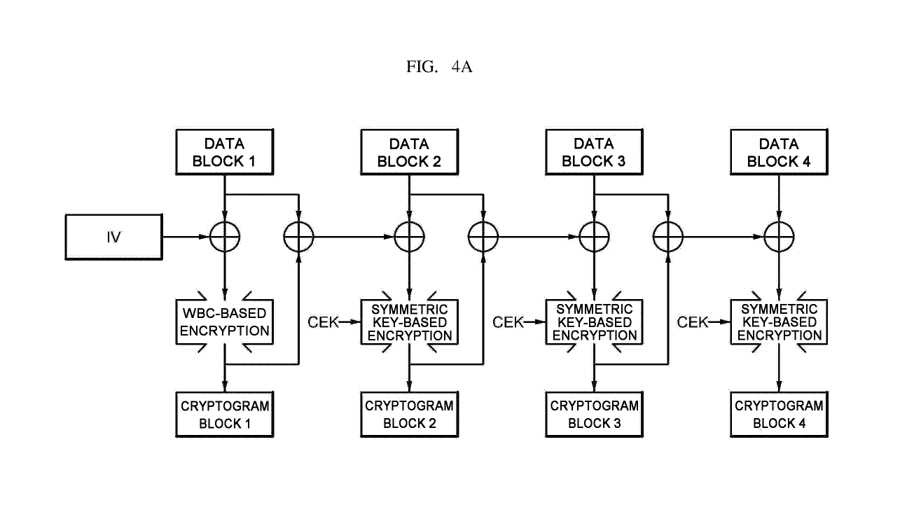

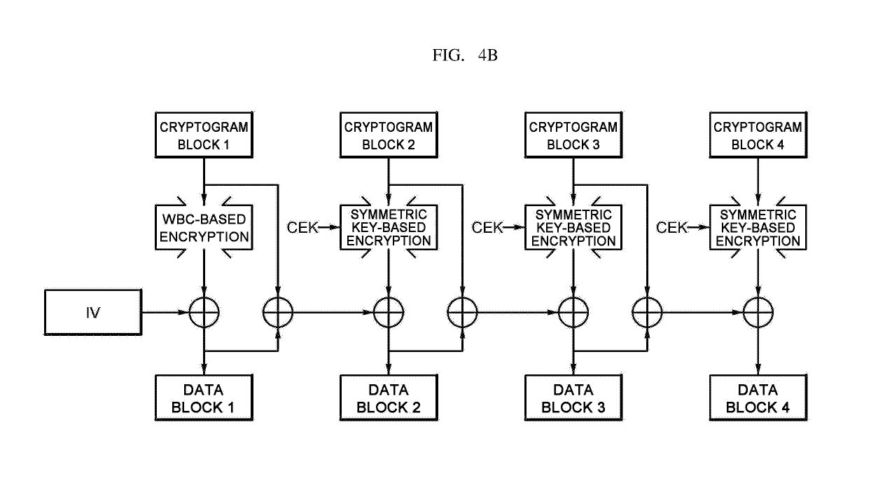

Hereinafter, referring to FIGS. 4 to 8, exemplary operations of the content encryption performed by the first encryption unit 110 of the DRM service provision apparatus 100 and the decryption of the encrypted content performed by the second decryption unit 350 of the content playback unit 300 of the content playback apparatus 300 will be described in detail.

Meanwhile, in examples shown in FIGS. 4 to 8, the WBC-based encryption may mean the WBC-based encryption in which the first secret key is internalized, and the WBC-based decryption may mean the WBC-based decryption in which the first secret key is internalized.

Further, a data block may mean content that is divided in units of blocks, and the cryptogram block may mean encrypted content that is divided in units of blocks.

An Implementation of Applying the WBC-Based Encryption to a Portion of Content to be Encrypted

According to an exemplary embodiment of the inventive concept, the first encryption unit 110 of the DRM service provision apparatus 100 may be configured to operate as follows.

The first encryption unit 110 may generate the WBC-based cryptogram by applying the WBC-based encryption in which the first secret key is internalized to a portion of the content.

After this, the first encryption unit 110 may generate the symmetric key-based cryptogram by applying the symmetric key-based encryption using the content encryption key CEK to a remaining portion of the content.

As described above, the operating mode for the content encryption may be defined so that the decryption of the WBC-based cryptogram is essential for the decryption of the symmetric key-based cryptogram. In this operating mode, when the WBC-based cryptogram is not decrypted, the content playback apparatus 300 may not decrypt the symmetric key-based cryptogram.

As an example, as shown in FIG. 4A, the first encryption unit 110 may perform an encryption operation in a propagating cipher block chaining (PCBC) mode. As shown in FIG. 4A, the first encryption unit 110 may perform an exclusive OR (XOR) operation on a first block (data block 1) of the content and an initialization vector IV, and generate a first cryptogram block (cryptogram block 1) by applying the WBC-based encryption algorithm in which the first secret key is internalized to the result of the XOR operation. After this, the first encryption unit 110 may perform an XOR operation on each of remaining blocks (data blocks 2 to 4) of the content, a previous data block, and a previous cryptogram block in order to generate blocks (cryptogram blocks 2 to 4) of the symmetric key-based cryptogram, and apply the symmetric key-based encryption using the content encryption key CEK to the result of the XOR operation. When supposing that the index of the first data block is “1” and the indices of the next data blocks are increased by 1, the encryption operation may be expressed by the following Equation 1.

C₁=E^{WBC}(P₁ XOR IV)

Cᵢ=E^{SYM}(Pᵢ XOR Pᵢ₋₁ XOR Cᵢ₋₁)(i≧2) [Equation 1]

Here, Cᵢ represents the i-th cryptogram block, Pᵢ represents the i-th data block, IV represents the initialization vector, E^{WBC} represents the WBC-based encryption algorithm, and XOR represents an XOR operation of blocks (for example, when each block is a bit sequence, an XOR operation for each bit).

Under the operating mode, the second decryption unit 350 may perform a decryption operation as shown in FIG. 4B. As shown in FIG. 4B, the second decryption unit 350 may decrypt the first block (cryptogram block 1) of the encrypted content using the WBC-based decryption in which the first secret key is internalized, and obtain the first data block (data block 1) by performing the XOR operation on the decrypted first block and the initialization vector IV. After this, the second decryption unit 350 may decrypt each of the remaining blocks (cryptogram blocks 2 to 4) of the encrypted content using the symmetric key-based decryption using the content encryption key CEK in order to obtain the remaining data blocks (data blocks 2 to 4) of the encrypted block, and perform the XOR operation on each of the decrypted remaining blocks, the previous data block, and the previous cryptogram block. The decryption operation may be expressed by the following Equation 2.

P₁=D^{WBC}(C₁)XOR IV

Pᵢ=D^{SYM}(Cᵢ)XOR Pᵢ₋₁ XOR Cᵢ₋₁(i≧2) [Equation 2]

Here, Cᵢ represents the i-th cryptogram block, Pᵢ represents the i-th data block, IV represents the initialization vector, D^{WBC} represents the WBC-based decryption algorithm, D^{SYM} represents the symmetric key-based decryption algorithm, and XOR represents an XOR operation of blocks (for example, when each block is a bit sequence, an XOR operation for each bit).

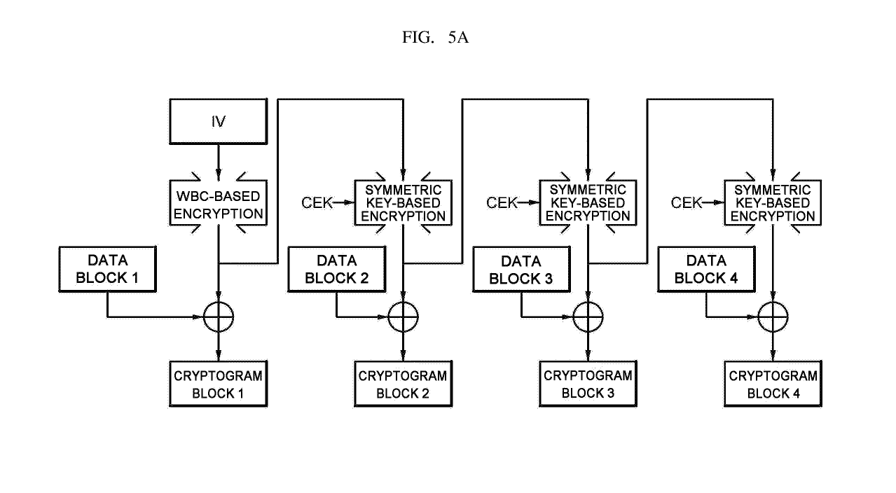

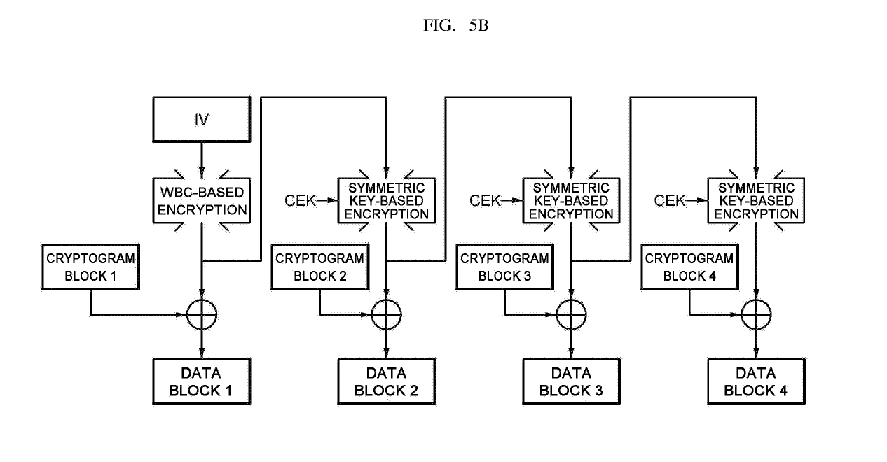

As another example, the first encryption unit 110 may perform the encryption operation in an output feedback (OFB) mode as shown in FIG. 5A. As shown in FIG. 5A, the first encryption unit 110 may generate a first output block by encrypting the initialization vector IV using the WBC-based encryption in which the first secret key is internalized, and generate the first cryptogram block (cryptogram block 1) by performing the XOR operation on the first output block and the first block (data block 1) of the content. After this, the first encryption unit 110 may generate the blocks (cryptogram blocks 2 to 4) the symmetric key-based cryptogram by encrypting the remaining blocks (data blocks 2 to 4) of the content using the symmetric-key encryption using the content encryption key CEK. In detail, the first encryption unit 110 may generate the i-th output block by encrypting the (i−1)-th output block using the symmetric key-based encryption, and generate the i-th cryptogram block by performing the XOR operation on the i-th output block and the i-th block of the content. The encryption operation may be expressed by the following Equation 3.

O₁=E^{WBC}(IV)

Oᵢ=E^{SYM}(Oᵢ₋₁)(i≧2)

Cᵢ=Pᵢ XOR Oᵢ(i≧1) [Equation 3]

Here, Cᵢ represents the i-th cryptogram block, Pᵢ represents the i-th data block, Oᵢ represents the i-th output block, IV represents the initialization vector, E^{WBC} represents the WBC-based encryption algorithm, E^{SYM} represents the symmetric key-based encryption algorithm, and XOR represents an XOR operation of blocks (for example, when each block is a bit sequence, an XOR operation for each bit).

Under the operating mode, the second decryption unit 350 may perform the decryption operation as shown in FIG. 5B. Referring to FIG. 5B, when considering the symmetry of the XOR operation, it may be known that the decryption operation may be performed like the encryption operation shown in FIG. 5A (that is, the WBC-based decryption and the symmetric key-based decryption for the decryption operation may be equal to the WBC-based encryption and the symmetric key-based encryption, respectively). The decryption operation may be expressed by the following Equation 4.

O₁=E^{WBC}(IV)

Oᵢ=E^{SYM}(Oᵢ₋₁)(i≧2)

Pᵢ=Cᵢ XOR Oᵢ(i≧1) [Equation 4]

Here, Cᵢ represents the i-th cryptogram block, Pᵢ represents the i-th data block, Oᵢ represents the i-th output block, IV represents the initialization vector, E^{WBC} represents the WBC-based encryption algorithm, E^{SYM} represents the symmetric key-based encryption algorithm, and XOR represents an XOR operation of blocks (for example, when each block is a bit sequence, an XOR operation for each bit).

An Implementation of Applying the WBC-Based Encryption to an Initialization Vector

According to an exemplary embodiment of the inventive concept, the first encryption unit 110 of the DRM service provision apparatus 100 may be configured to operate as follows.

The first encryption unit 110 may generate the WBC-based cryptogram by applying the WBC-based encryption in which the first secret key is internalized to the initialization vector IV.

After this, the first encryption unit 110 may generate the symmetric key-based cryptogram by applying the symmetric key-based encryption using the content encryption key to the content.

In the exemplary implementation, the operating mode for the content encryption may be defined so that the decryption of the WBC-based cryptogram is essential for the decryption of the symmetric key-based cryptogram. As described above, in the operating mode, the content playback apparatus 300 may decrypt the WBC-based cryptogram in order to decrypt the symmetric key-based cryptogram included in the encrypted content.

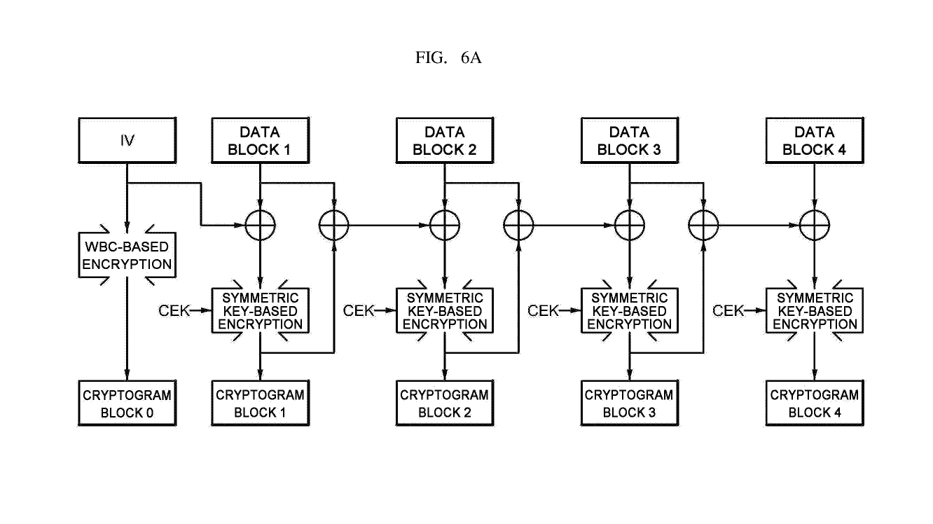

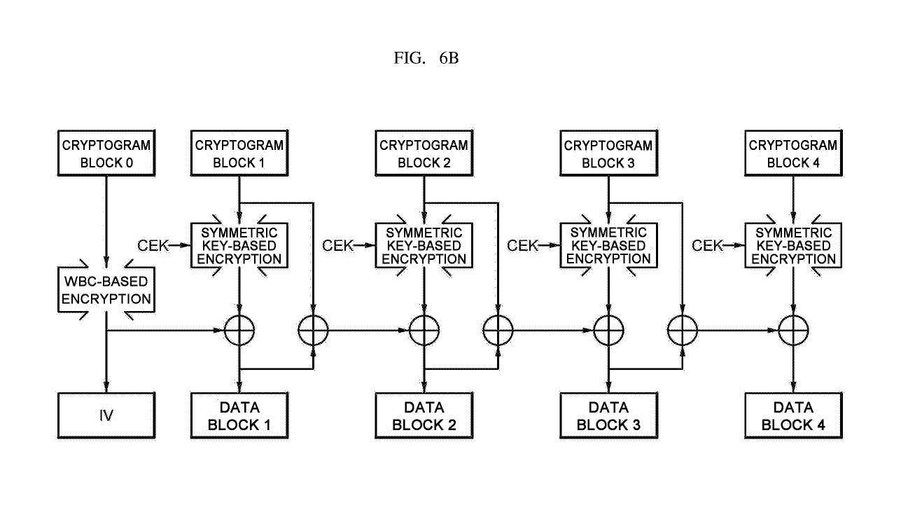

As an example, the first encryption unit 110 may perform the encryption operation in the PCBC mode as shown in FIG. 6A. As shown in FIG. 6A, the first encryption unit 110 may generate the WBC-based cryptogram block (cryptogram block 0) by encrypting the initialization vector IV using the WBC-based encryption in which the first secret key is internalized.

After this, the first encryption unit 110 may generate the blocks (cryptogram blocks 1 to 4) of the symmetric key-based cryptogram by encrypting each block (data blocks 1 to 4) of the content using the symmetric-key encryption using the content encryption key CEK. In detail, the first encryption unit 110 may perform the XOR operation on the first block (data block 1) of the content and the initialization vector IV, and generate the cryptogram block 1 by applying the WBC-based encryption to the result of the XOR operation. Next, the first encryption unit 110 may perform the XOR operation on each of the remaining blocks (data blocks 2 to 4) of the content, the previous data block, and the previous cryptogram block, and apply the symmetric key-based encryption to the result of the XOR operation. When the index of the first data block is “1” and the indexes of next data blocks are increased by 1, the encryption operation may be expressed by the following Equation 5.

C₀=E^{WBC}(IV

C₁=E^{SYM}(P₁ XOR IV)

Cᵢ=E^{SYM}(Pᵢ XOR Pᵢ₋₁ XOR Cᵢ₋₁)(i≧2) [Equation 5]

Here, Cᵢ represents the i-th cryptogram block, Pᵢ represents the i-th data block, IV represents the initialization vector, E^{WBC} represents the WBC-based encryption algorithm, E^{SYM} represents the symmetric key-based encryption algorithm, and XOR represents an XOR operation of blocks (for example, when each block is a bit sequence, an XOR operation for each bit).

Under the operating mode, the second decryption unit 350 may perform the decryption operation as shown in FIG. 6B. As shown in FIG. 6B, the second decryption unit 350 may obtain the initialization vector IV by decrypting a 0-th block (cryptogram block 1) of the encrypted content using the WBC-based decryption in which the first secret key is internalized.

After this, the second decryption unit 350 may decrypt the first block (cryptogram block 1) of the encrypted content using the symmetric key-based decryption using the content encryption key CEK, perform the XOR operation on the decrypted first block and the initialization vector IV, and obtain the first data block (data block 1). Next, the second decryption unit 350 may decrypt each of the remaining blocks (cryptogram blocks 2 to 4) of the encrypted content using the symmetric key-based decryption using the content encryption key CEK, and perform the XOR operation on each of the decrypted remaining blocks, the previous data block, and the previous cryptogram block. The decryption operation may be expressed by the following Equation 6.

IV=D^{WBC}(C₀)

P₁=D^{SYM}(C₁)XOR IV

Pᵢ=D^{SYM}(Cᵢ)XOR Pᵢ₋₁ XOR Cᵢ₋₁(i≧2) [Equation 6]

Here, Cᵢ represents the i-th cryptogram block, Pᵢ represents the i-th data block, IV represents the initialization vector, D^{WBC} represents the WBC-based decryption algorithm, D^{SYM} represents the symmetric key-based decryption algorithm, and XOR represents an XOR operation of blocks (for example, when each block is a bit sequence, an XOR operation for each bit).

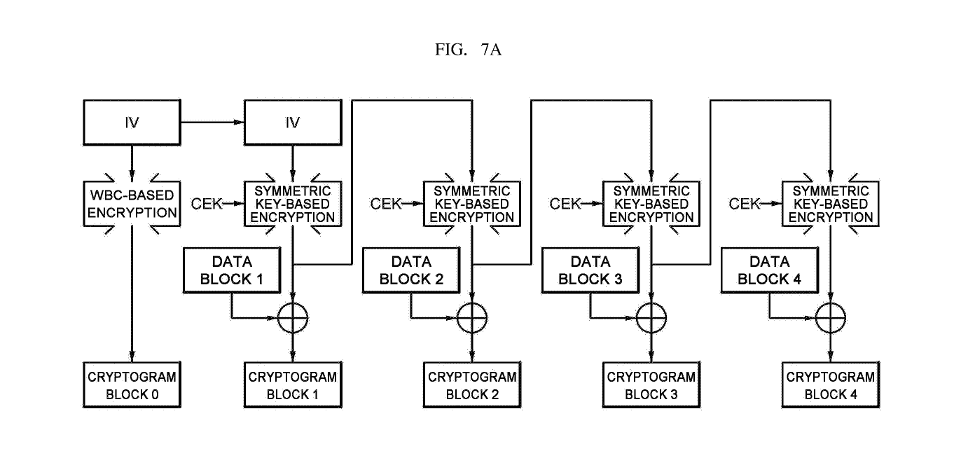

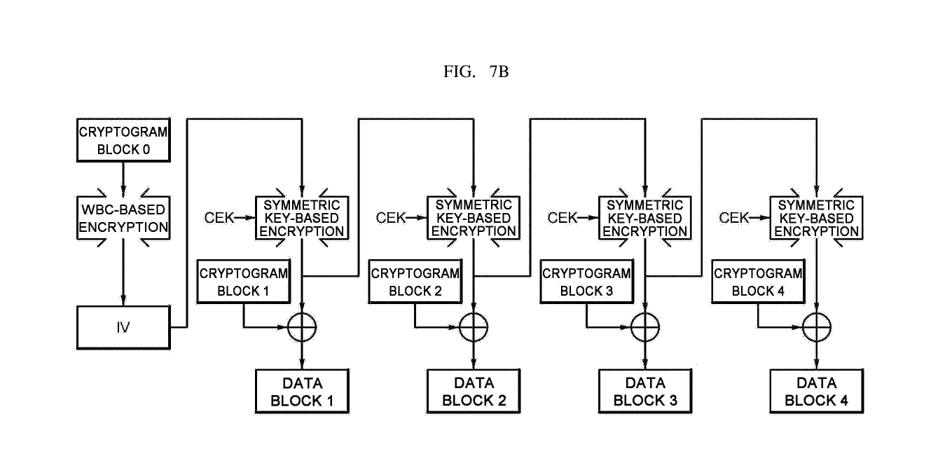

As another example, the first encryption unit 110 may perform the encryption operation in the OFB mode as shown in FIG. 7A. As shown in FIG. 7A, the first encryption unit 110 may generate the WBC-based cryptogram block (cryptogram block 0) by encrypting the initialization vector IV using the WBC-based encryption in which the first secret key is internalized.

After this, the first encryption unit 110 may generate the blocks (cryptogram blocks 1 to 4) of the symmetric key-based cryptogram by encrypting each of the blocks (data blocks 1 to 4) of the content using the symmetric key-based encryption using the content encryption key CEK. In detail, the first encryption unit 110 may generate the first output block by encrypting the initialization vector IV using the symmetric key-based encryption, and generate the first cryptogram block (cryptogram block 1) by performing the XOR operation on the output block and the first block (data block 1) of the content. Next, the first encryption unit 110 may generate the i-th output block by encrypting an (i−1)-th output block using the symmetric key-based encryption using the content encryption key CEK, and generate the i-th cryptogram block by performing the XOR operation on the i-th output block and the i-th block of the content. The encryption operation may be expressed by the following Equation 7.

C₀=E^{WBC}(IV)

O₁=E^{SYM}(IV)

Oᵢ=E^{SYM}(Oᵢ₋₁)(i≧2)

Cᵢ=Pᵢ XOR Oᵢ(i≧1) [Equation 7]

Here, Cᵢ represents the i-th cryptogram block, Pᵢ represents the i-th data block, Oᵢ represents the i-th output block, IV represents the initialization vector, E^{WBC} represents the WBC-based encryption algorithm, E^{SYM} represents the symmetric key-based encryption algorithm, and XOR represents an XOR operation of blocks (for example, when each block is a bit sequence, an XOR operation for each bit).

Under the operating mode, the second decryption unit 350 may perform the decryption operation as shown in FIG. 7B. Referring to FIG. 7B, it may be necessary for the decryption operation to obtain the initialization vector IV using the WBC-based decryption in which the first secret key is internalized, but it may be shown that the decryption operation on the remaining portion (that is, the symmetric key-based decryption for the decryption operation) may be performed like the encryption operation described above. The decryption operation may be expressed by the following Equation 8.

IV=D^{WBC}(C₀)

O₁=E^{SYM}(IV)

Oᵢ=E^{SYM}(Oᵢ₋₁)(i≧2)

Pᵢ=Cᵢ XOR Oᵢ(i≧1) [Equation 8]

Here, Cᵢ represents the i-th cryptogram block, Pᵢ represents the i-th data block, Oᵢ represents the i-th output block, IV represents the initialization vector, D^{WBC} represents the WBC-based decryption algorithm, D^{SYM} represents the symmetric key-based decryption algorithm, and XOR represents an XOR operation of blocks (for example, when each block is a bit sequence, an XOR operation for each bit).

An Implementation of Applying the Encryption in a Counter Mode

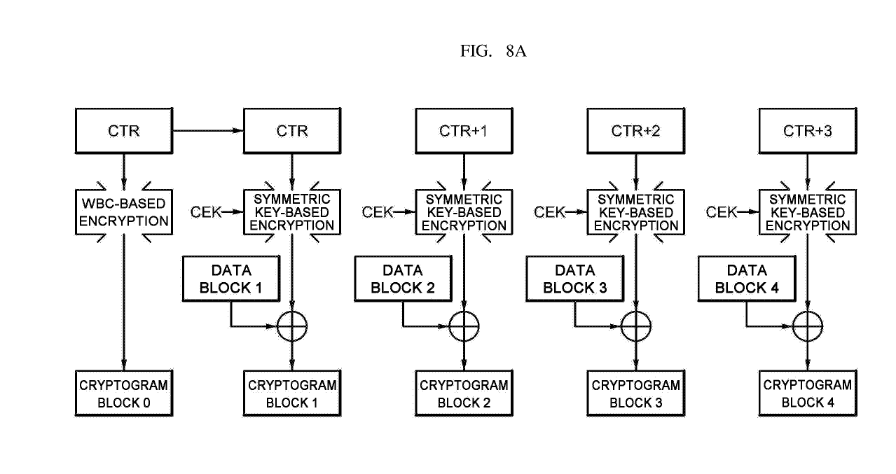

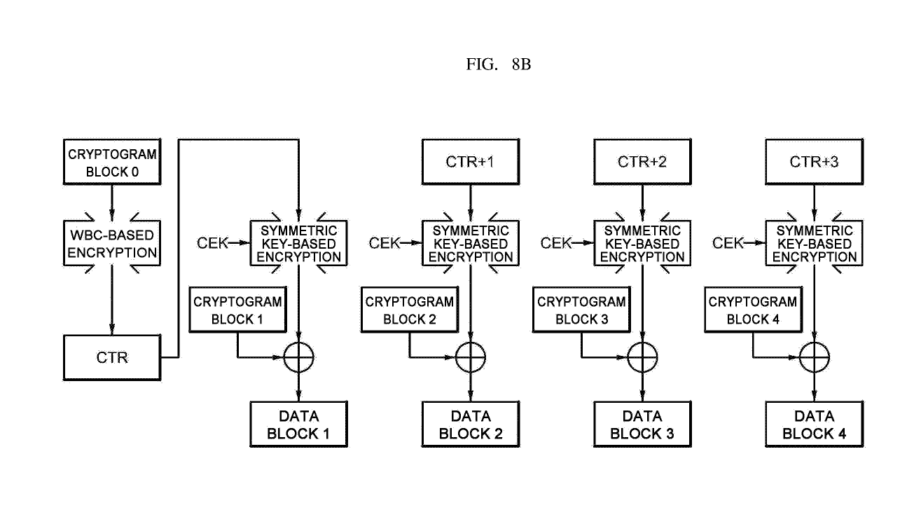

According to an exemplary embodiment of the inventive concept, the first encryption unit 110 of the DRM service provision apparatus 100 may perform the encryption operation in a counter mode as shown in FIG. 8A. In order to perform the encryption operation, the first encryption unit 110 may generate the counter values using a counter function (for example, a function outputting the counter value starting from an initial counter value and increasing by 1) which does not generate repeated values for a long time. As shown in FIG. 8A, the first encryption unit 110 may generate the WBC-based cryptogram block (cryptogram block 0) by encrypting the initial counter value CTR using the WBC-based encryption in which the first secret key is internalized.

After this, the first encryption unit 110 may generate the blocks (cryptogram blocks 1 to 4) of the symmetric key-based cryptogram by encrypting each block of the content using the symmetric-key encryption using the content encryption key CEK. In detail, the first encryption unit 110 may encrypt the initial counter value CTR using the symmetric key-based encryption using the content encryption key CEK, and generate the first cryptogram block (cryptogram block 1) by performing the XOR operation on the encrypted initial counter value and the first block (data block 1) of the content. Similarly, the first encryption unit 110 may encrypt the i-th counter value (for example, as shown in FIG. 8A, CTR+i−1) using the symmetric key-based encryption using the content encryption key CEK, and generate the i-th cryptogram block by performing the XOR operation on the encrypted i-th counter value and the i-th block of the content. In this case, each cryptogram block may be generated in parallel.

Under the operating mode, the second decryption unit 350 may perform the decryption operation as shown in FIG. 8B. Referring to FIG. 8B, it may be necessary for the decryption operation to obtain the initial counter value CTR using the WBC-based decryption in which the first secret key is internalized, but it may be shown that the decryption operation on the remaining portion (that is, the symmetric key-based decryption for the decryption operation) may be performed like the encryption operation described above.

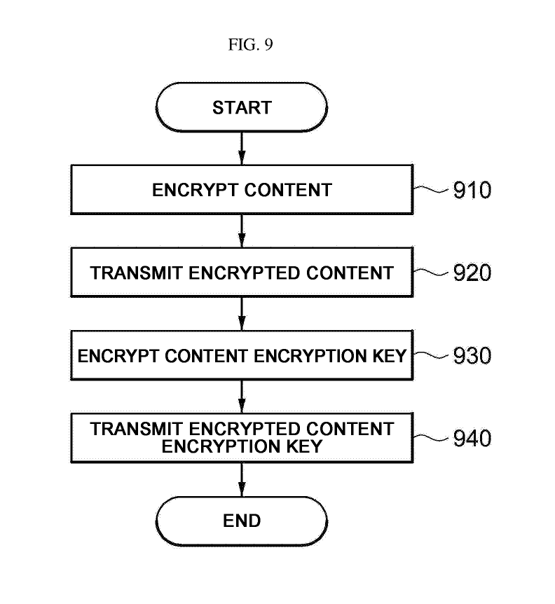

FIG. 9 is a flowchart for describing a DRM service provision method according to an exemplary embodiment of the inventive concept.

A method shown in FIG. 9, for example, may be performed by the DRM service provision apparatus 100 shown in FIG. 2.

Referring to FIG. 9, the DRM service provision apparatus 100 may encrypt the content using the WBC-based encryption in which the first secret key is internalized and the symmetric key-based encryption using the content encryption key (910).

After this, the DRM service provision apparatus 100 may transmit the encrypted content to the content playback apparatus of the registered user (920).

After this, the DRM service provision apparatus 100 may encrypt the content encryption key used for the content encryption using a second WBC-based encryption in which the second secret key of the registered user is internalized (930).

After this, the DRM service provision apparatus 100 may transmit the encrypted content encryption key to the content playback apparatus of the registered user (940).

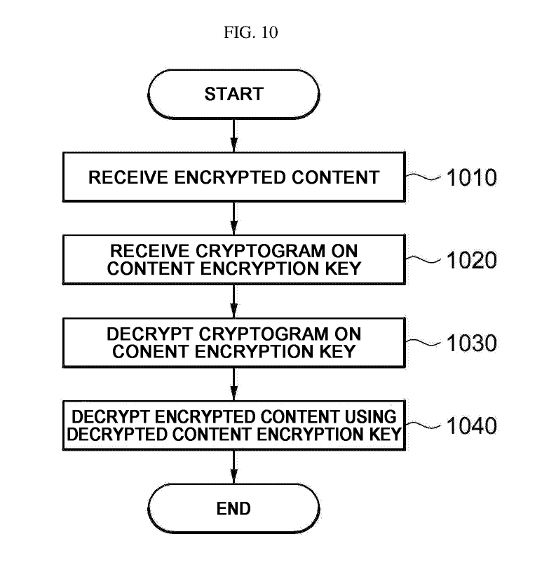

FIG. 10 is a flowchart for describing a content playback method according to an exemplary embodiment of the inventive concept.

A method shown in FIG. 10, for example, may be performed by the content playback apparatus 300 shown in FIG. 3.

Referring to FIG. 10, the content playback apparatus 300 may receive the encrypted content from the DRM service provision apparatus 100 (1010).

After this, the content playback apparatus 300 may receive the cryptogram on the content encryption key used for encrypting the encrypted content (1020).

After this, the content playback apparatus 300 may decrypt the cryptogram on the received content encryption key using the WBC-based decryption in which the second secret key is internalized (1030).

After this, the content playback apparatus 300 may decrypt the encrypted content using the WBC-based decryption in which the first secret key is internalized and the symmetric key-based decryption using the decrypted content encryption key (1040).

Meanwhile, in the flowcharts shown in FIGS. 9 and 10, the methods are described by being divided into a plurality of operations, but at least one portion of the operations may be performed by changing the order, be performed by being combined with another operation, be omitted, be performed by being divided into sub-operations, or be performed by adding one or more operations which are not shown.

Meanwhile, an exemplary embodiment of the inventive concept may include a computer-readable recording medium including a program for executing the methods described herein in a computer. The computer-readable recording medium may include a program instruction, a local data file, a local data structure, etc. alone or in combination. The computer readable recording medium may be specially designed and be configured for the inventive concept, or may be a medium which is generally used in the computer software field. Examples of the computer-readable recording medium may include a hard disk, a magnetic media such as a floppy disk and a magnetic tape, an optical recording media such as a compact disk (CD)-ROM and a digital video disk (DVD), a magneto-optical media such as a floptical disk, and a hardware device which is specially configured to store and execute a program instruction, such as a read only memory (ROM), a random access memory (RAM), a flash memory, etc. Examples of the program instruction may include not only machine code made by a compiler but also high-level language code which is executable by a computer using an interpreter, etc.

According to exemplary embodiments of the inventive concept, the structure for the content encryption is simple since the public key encryption algorithm used in the conventional DRM is not used, and the stability and the speed of the DRM service may be improved since a corresponding key is not exposed even to the memory attacks because the secret key used for the content encryption is protected using the WBC algorithm.

While the exemplary embodiments of the inventive concept are described in detail above, it will be understood by those of ordinary skill in the art that various changes and modifications in form and details may be made therein without departing from the spirit and scope as defined by the following claims. Accordingly, the scope of the inventive concept is not limited by the exemplary embodiments of the inventive concept, it is intended that the present disclosure covers all such modifications and changes of those of ordinary skill in the art derived from a basic concept of the appended claims, and their equivalents.

What is claimed is:

1. A digital rights management (DRM) provision apparatus, comprising:
a first encryptor configured to encrypt content using a first white-box cryptograph (WBC)-based encryption, in which a first secret key is internalized, and a symmetric key-based encryption using a content encryption key;
a second encryptor configured to encrypt the content encryption key using a second WBC-based encryption in which a second secret key is internalized; and
a transmitter configured to transmit the encrypted content and the encrypted content encryption key to a content playback apparatus of a registered user.

2. The DRM service provision apparatus of claim 1, wherein the encrypted content comprises a first cryptogram encrypted by the first WBC-based encryption and a second cryptogram encrypted by the symmetric key-based encryption.

3. The DRM service provision apparatus of claim 2, wherein the first encryptor is further configured to generate the first cryptogram by applying the first WBC-based encryption to a portion of the content or a seed value, and generate the second cryptogram by applying the symmetric key-based encryption to another portion of the content to which the first WBC-based encryption is not applied.

4. The DRM service provision apparatus of claim 3, wherein the first encryptor is further configured to generate the second cryptogram based on the portion of the content or the seed value.

5. The DRM service provision apparatus of claim 3, wherein the seed value comprises an initialization vector or a counter value.

6. The DRM service provision apparatus of claim 1, wherein the first secret key comprises a server secret key.

7. The DRM service provision apparatus of claim 1, wherein the second secret key comprises a user secret key.

8. A DRM service provision method, comprising:
encrypting content using a first WBC-based encryption, in which a first secret key is internalized, and a symmetric key-based encryption using a content encryption key;
encrypting the content encryption key using a second WBC-based encryption in which a second secret key is internalized; and
transmitting the encrypted content and the encrypted content encryption key to a content playback apparatus of a registered user.

9. The DRM service provision method of claim 8, wherein the encrypted content comprises a first cryptogram encrypted by the first WBC-based encryption and a second cryptogram encrypted by the symmetric key-based encryption.

10. The DRM service provision method of claim 9, wherein the encrypting the content comprises:
generating the first cryptogram by applying the first WBC-based encryption to a portion of the content or a seed value; and
generating the second cryptogram by applying the symmetric key-based encryption to another portion of the content to which the first WBC-based encryption is not applied.

11. The DRM service provision method of claim 10, wherein the generating the second cryptogram comprises generating the second cryptogram based on the portion of the content or the seed value.

12. The DRM service provision method of claim 10, wherein the seed value comprises an initialization vector or a counter value.

13. The DRM service provision method of claim 8, wherein the first secret key comprises a server secret key.

14. The DRM service provision method of claim 8, wherein the second secret key comprises a user secret key.

15. A content playback apparatus, comprising:
a receiver configured to receive encrypted content and a cryptogram on a content encryption key, the content encryption key being used to generate the encrypted content;
a first decryptor configured to decrypt the cryptogram on the content encryption key using a first WBC-based decryption in which a first secret key is internalized; and
a second decryptor configured to decrypt the encrypted content using a second WBC-based decryption, in which a second secret key is internalized, and a symmetric key-based decryption using the content encryption key.

16. The content playback apparatus of claim 15, wherein the encrypted content comprises a first cryptogram encrypted using a WBC-based encryption, in which the second secret key is internalized, and a second cryptogram encrypted using a symmetric key-based encryption using the content encryption key, and
the second decryptor is further configured to apply the second WBC-based decryption to the first cryptogram, apply the symmetric key-based decryption to the second cryptogram, and decrypt the encrypted content.

17. The content playback apparatus of claim 16, wherein the second decryptor is further configured to decrypt the second cryptogram using information decrypted by the second WBC-based decryption.

18. The content playback apparatus of claim 17, wherein the decrypted information comprises a portion of content or a seed value.

19. The content playback apparatus of claim 18, wherein the seed value comprises an initialization vector or a counter value.

20. The content playback apparatus of claim 15, wherein the second secret key comprises a server secret key.

21. The content playback apparatus of claim 15, wherein the first secret key comprises a user secret key.

22. A content playback method, comprising:
receiving encrypted content and a cryptogram on a content encryption key, the content encryption key being used to generate the encrypted content;
decrypting the cryptogram on the content encryption key using a first WBC-based decryption in which a first secret key is internalized; and
decrypting the encrypted content using a second WBC-based decryption, in which a second secret key is internalized, and a symmetric key-based decryption using the content encryption key.

23. The content playback method of claim 22, wherein the encrypted content comprises a first cryptogram encrypted using a WBC-based encryption, in which the second secret key is internalized, and a second cryptogram encrypted using a symmetric key-based encryption using the content encryption key, and
the decrypting the encrypted content comprises applying the second WBC-based decryption to the first cryptogram, applying the symmetric key-based decryption to the second cryptogram, and decrypting the encrypted content.

24. The content playback method of claim 23, wherein the decrypting the encrypted content comprises decrypting the second cryptogram using information decrypted by the second WBC-based decryption.

25. The content playback method of claim 24, wherein the decrypted information comprises a portion of content or a seed value.

26. The content playback method of claim 25, wherein the seed value comprises an initialization vector or a counter value.

27. The content playback method of claim 23, wherein the second secret key comprises a server secret key.

28. The content playback method of claim 23, wherein the first secret key comprises a user secret key.

29. A computer-readable recording medium storing a program which, when executed by a computer, causes the computer to perform a method comprising:
encrypting content using a first WBC-based encryption, in which a first secret key is internalized, and a symmetric key-based encryption using a content encryption key;
encrypting the content encryption key using a second WBC-based encryption in which a second secret key is internalized; and
transmitting the encrypted content and the encrypted content encryption key to a content playback apparatus of a registered user.

30. A computer-readable recording medium storing a program which, when executed by a computer, causes the computer to perform a method comprising:
receiving encrypted content and a cryptogram on a content encryption key, the content encryption key being used to generate the encrypted content;
decrypting the cryptogram on the content encryption key using a first WBC-based decryption in which a first secret key is internalized; and
decrypting the encrypted content using a second WBC-based decryption, in which a second secret key is internalized, and a symmetric key-based decryption using the content encryption key.
